(19) United States
(12) Patent Application Publication
(10) Pub. No.: US 2024/0346465 A1
(43) Pub. Date: Oct. 17, 2024

(54) TOKEN OF DYNAMICALLY ADJUSTABLE VALUE

(71) Applicant: Intuit, Inc., Mountain View, CA (US)

(72) Inventors: Christopher Mankit Chan, San Jose, CA (US); Jothimani Kanthan Ganapathi, Castro Valley, CA (US); Jason Daniel Taylor, Sunnyvale, CA (US); Glenn Scott, Portola Valley, CA (US)

(21) Appl. No.: 18/133,491

(22) Filed: Apr. 11, 2023

(51) Int. Cl. G06Q 20/02

(52) U.S. Cl. CPC G06Q 20/02; G06Q 2220/00

(57) ABSTRACT

Certain aspects of the disclosure provide a method for transacting on a blockchain with an amount of user token for a transfer; an amount of user token for funding the transfer; and an amount of system token for paying a cost of the transfer, wherein the amount of user token for funding the transfer is determined to be equivalent to the amount of system token for paying the cost of the transfer; executing the transfer of user token; and reimbursing the amount of system token paid for the cost of the transfer.

### BACKGROUND

### Field

Aspects of the present disclosure relate to systems and methods for generating a fungible token with a dynamically adjustable value for a blockchain.

### Description of Related Art

A blockchain network (blockchain for short) is generally a distributed database or ledger that is shared among nodes of a computer network, and thus sometimes referred to as a blockchain network. Blockchains are generally configured to store information electronically in a digital format, such as the record of ownership of an asset, like a crypto token, currency, or other crypto-based asset.

Transactions on the blockchain are recorded as blocks of data as the transaction occurs. Each block of data is linked to both the prior block of data and the subsequent block of data. Thus, the series of linked blocks forms an immutable ledger. Such transactions may include, for example, asset transfers and process operations, and others.

A fee is generally paid to process each transaction on a blockchain. For example, blockchain miners or validators receive the fee in exchange for validating and confirming a transaction is recorded on the blockchain. Generally, the transaction fee is related to the computational effort required to execute the transaction on the blockchain. Transaction fees may depend on the size of the transaction, network congestion, transaction time, supply of validators, demand for transaction verification, and others. For example, the transaction fee will be higher for large-sized transactions and when the blockchain is busier.

Blockchains are generally configured such that transaction fees must be paid in the blockchain's native currency. For example, transactions on an Ethereum blockchain need to be paid in its native currency, ether or “ETH”. However, services built on top of blockchains may be configured to use other types of crypto assets for providing services and transactions, such as fungible tokens and non-fungible tokens. In some cases, such as for tax reasons, there may be a need to avoid using native currencies that have defined economic values, such as ETH, when paying the cost (sometimes referred to as “gas”) for a blockchain-based transaction. Generally, such non-native tokens cannot be used directly to pay transaction fees.

Consequently, a technical problem exists in the art in which it is not possible to transact on a blockchain without utilizing the blockchain's native currency. Accordingly, there is a need for methods of transacting on a blockchain with non-native currencies (e.g., non-native tokens).

### SUMMARY

Certain aspects of the disclosure provide a method, comprising: receiving, by a smart contract, from a first user via a blockchain: a first amount of user token for a transfer from the first user to a second user; a second amount of user token to fund the transfer within the blockchain, wherein the second amount is a cost associated with the transfer within the blockchain; and a first amount of system token, wherein the first amount of system token is an estimate of the cost associated with the transfer within the blockchain; determining, by the smart contract, a second amount of system token for performing the transfer; determining, by the smart contract, a third amount of user token equivalent to the second amount of system token for performing the transfer; executing the transfer of the first amount of user token to the second user on the blockchain; transferring, by the smart contract, to the first user, a third amount of system token, wherein the third amount of system token is a difference between the first amount of system token and the second amount of system token; and transferring, by the smart contract, to the first user, the second amount of system token.

Certain aspects of the disclosure provide a method, comprising: receiving, by a smart contract, from a first user via a blockchain: a first amount of user token for a transfer from the first user to a second user; a first amount of system token, wherein the first amount of system token is an estimate of the cost associated with the transfer within the blockchain; determining, by the smart contract, a second amount of system token for performing the transfer; executing the transfer of the first amount of user token to the second user on the blockchain; transferring, by the smart contract, to the first user, a third amount of system token, wherein the third amount of system token is a difference between the first amount of system token and the second amount of system token; and transferring, by the smart contract, to the second user, the second amount of system token.

Other aspects provide processing systems configured to perform the aforementioned methods as well as those described herein; non-transitory, computer-readable media comprising instructions that, when executed by a processor of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system for transacting on a blockchain with a user token with a dynamically adjustable value.

FIG. 2 depicts an example flowchart for transacting on a blockchain with a user token with a dynamically adjustable value.

FIG. 3 depicts another example flowchart for transacting on a blockchain with a user token with a dynamically adjustable value.

FIG. 4 depicts an example method for transacting on a blockchain with a user token with a dynamically adjustable value.

FIG. 5 depicts another example method for transacting on a blockchain with a user token with a dynamically adjustable value.

FIG. 6 depicts another example method for transacting on a blockchain with a user token with a dynamically adjustable value.

FIGS. 7A-7C depict example processing systems with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for performing blockchain transactions with a non-native fungible token (or user token) having a dynamically adjustable value based on the token's ability to fund transitions within the blockchain. Specifically, aspects described herein utilize a smart contract embedded in the blockchain to provide a custom non-native fungible token that derives its value from its ability to fund transactions on the blockchain. As such, unlike conventional cryptocurrency assets, the face-value of the non-native fungible token remains fixed, even as the cost of transacting on the blockchain varies.

Tokens that are not native to a particular blockchain may still be transferred and otherwise used on blockchain for many purposes. Non-native tokens may be created by users, organizations, central authorities, or even by decentralized autonomous organizations. However, as discussed above, a technical problem exists in the art in which non-native tokens cannot be used for paying the transaction fees (or gas) on a blockchain. Conventionally, users transacting using non-native tokens must pay the transaction fees with native tokens.

In some situations, it may be unclear the relationship between the non-native token and native token. For example, the user may wish to transfer non-native tokens, but because transaction fees must be paid in native tokens, it may be difficult to determine the actual cost to the user between the two currencies: native and non-native. Often to determine the relationship between a native and non-native currency, each type of currency must be calculated in terms of a third standard, often a fiat currency, to determine the relative value of each currency.

As another example, a user may establish a smart contract or a decentralized application (dApp) on the blockchain and wish to utilize non-native tokens in the operations of the smart contract, however, the smart contract will need to be funded with native tokens. It may be difficult to predict the costs of executing the smart contract in native tokens, and the smart contract must then account for both the native and non-native tokens in its operations.

Thus, conventional non-native tokens cannot operate on a blockchain as a native token. However, transacting with non-native tokens could be improved if the non-native token could be used to pay transaction fees, directly or indirectly, thereby allowing the non-native token to function natively on the blockchain.

Accordingly, aspects described herein relate to a non-native token with improved functionality such that the non-native token may be used to indirectly pay transaction fees. For example, aspects described herein are directed to a non-native token with a dynamically adjustable value relative to the native token.

Beneficially, from a user's perspective native currency is not used to pay transaction fees, and instead a non-native token is used. Thus, aspects described herein provide technical solutions to the technical problems described above by using a non-native token to indirectly pay transaction fees. Further, the non-native token's value may be based on its utility on the blockchain, allowing users to more readily predict the transaction cost. For example, a non-native token value may be based on its ability to fund transactions on the blockchain, such as mapping the non-native token value to the cost of transacting on the blockchain using system token. In aspects described herein, the non-native token value may dynamically adjust as the cost of transacting varies. Thus, beneficially, the non-native token need not be pegged to a fiat currency for value, and the non-native token retains a consistent value and utility, irrespective of the value of system token.

Additionally, from the user's perspective, the improved non-native token may be used to pay transaction fees, such that the user's wallet balance will reflect all operations in the non-native currency. Furthermore, the improved non-native token may be operated by different authorities, including central authorities or decentralized autonomous organizations to set the utility and function of the improved non-native token.

### Example System for Transacting on a Blockchain

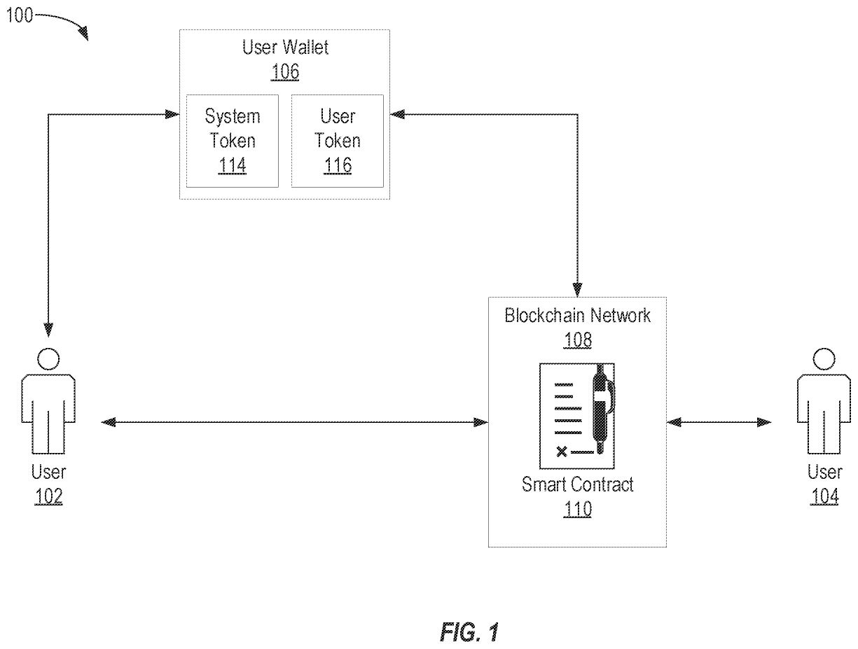

FIG. 1 depicts an example system 100 for transacting on a blockchain using the improved non-native token described herein. Generally, user 102 may transact on blockchain 108.

Blockchain 108 may be any type of blockchain that supports operating programmed processes. In various embodiments, blockchain 108 may be an Ethereum-type network, Bitcoin-type network, a Binance smart chain-type network, a Cardano-type network, a Solana-type network, etc.

User 102 has a wallet 106 that holds the user's tokens, here system token (or native token) 114 and user token (or non-native token) 116. In some instances, wallet 106 may hold one or more types of tokens, such as user token, system token, and non-fungible tokens (NFT).

User token 116 has a dynamically adjustable value relative to system token 114 to preserve the utility of user token 116. In some applications, user token 116 is mapped to the cost of transacting on blockchain 108 using system token 114. User token 116 retains a set utility, despite any value changes in system token 114. For example, if a greater amount of system token 114 is needed for a transaction on blockchain 108, the equivalent amount of user token 116 remains fixed. As another example, if a lesser amount of system token 114 is needed for a transaction on blockchain 108, the equivalent amount of user token 116 still remains fixed.

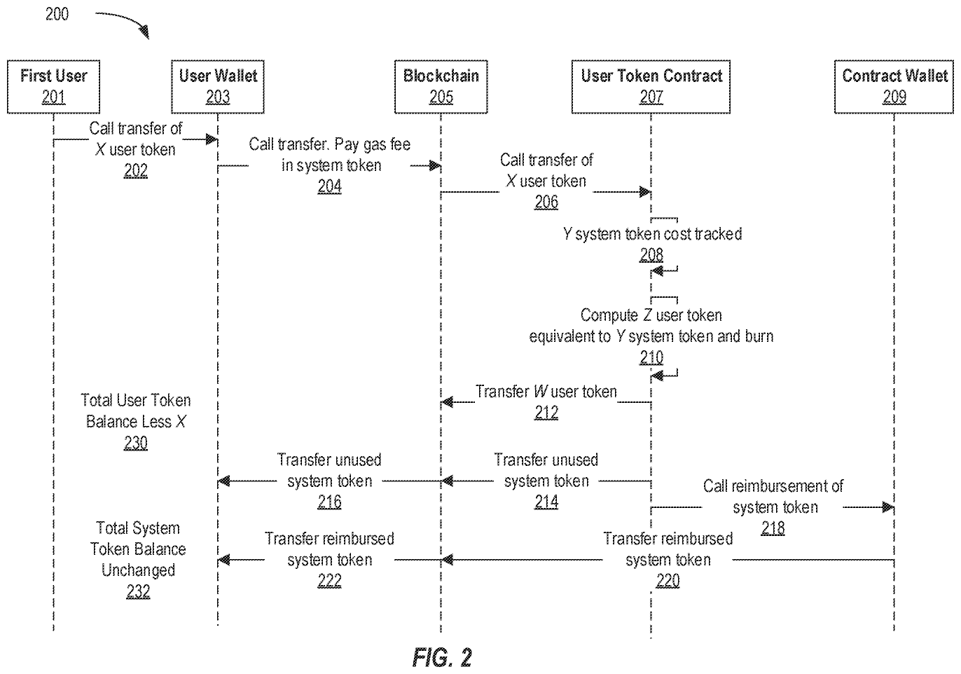

One or more smart contracts 110 may operate on blockchain 108. A smart contract is a program published and stored on a blockchain network that automatically runs when the conditions written into the smart contract are met by utilizing cryptographically signed transactions on a blockchain. Decentralized applications, often referred to as “dApps,” are applications built on a blockchain using blockchain for data storage and smart contracts for programming. In this example, smart contract 110 is an ERC-20 type smart contract that creates and operates user token 116. Note that in this example smart contract 110 is described as an ERC-20 type smart contract, but in other examples, other methods for creating and operating user tokens are possible. Smart contract 110 may implement the methods described below with respect to FIGS. 2-6.

User 102 may perform various transactions on blockchain 108. For example, a user 102 may use blockchain 108 to transfer user token 116 to another user 104. In such an example, user 102 instructs blockchain 108 to send user token 116 from the user's wallet 106 to user 104. When transferring user token 116, blockchain 108 calls on smart contract 110 to execute the transfer. Conventionally, user 102 pays transaction fees in system token 114 to facilitate the transfer.

As described in detail with reference to FIG. 2, and various embodiments of the present disclosure, user token 116 may be used to indirectly pay the transaction fee. Specifically, user 102 pays an equivalent amount of user token 116, according to a dynamically variable exchange rate, to the transaction fee in system token 114, and smart contract 110 reimburses the user's wallet 106 for the system token 114 spent in transaction fees, such that there is no actual economic value exchanged. Beneficially, this is reflected in the token balances of the user's wallet 106 following the transaction because user's wallet 106 has a decrease in the user's balance of user token 116, but no net change in system token 114 due to the reimbursement.

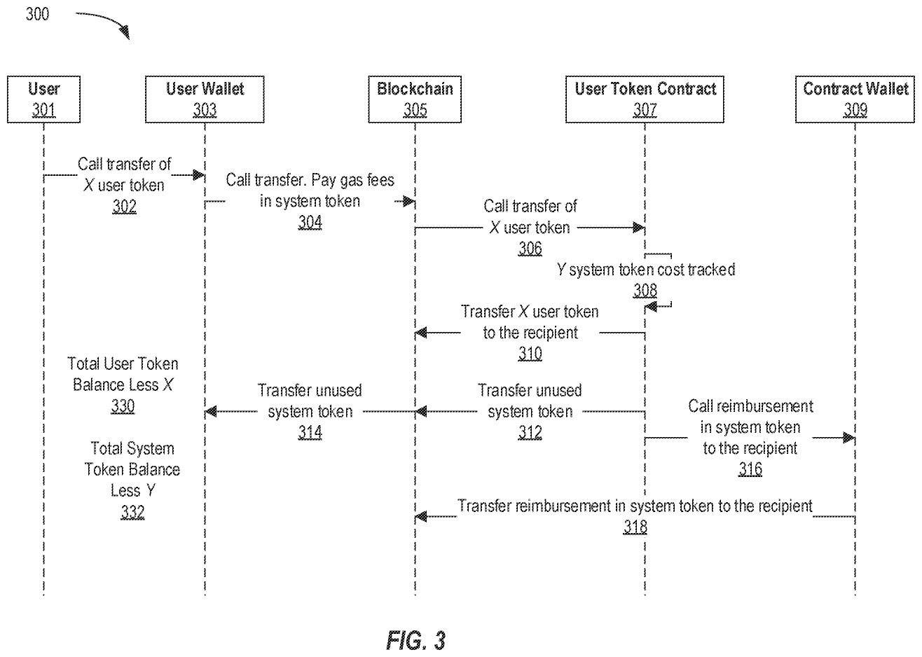

As described in detailed with reference to FIG. 3, and various embodiments of the present disclosure, user 102 and user 104 may share in the transaction fee.

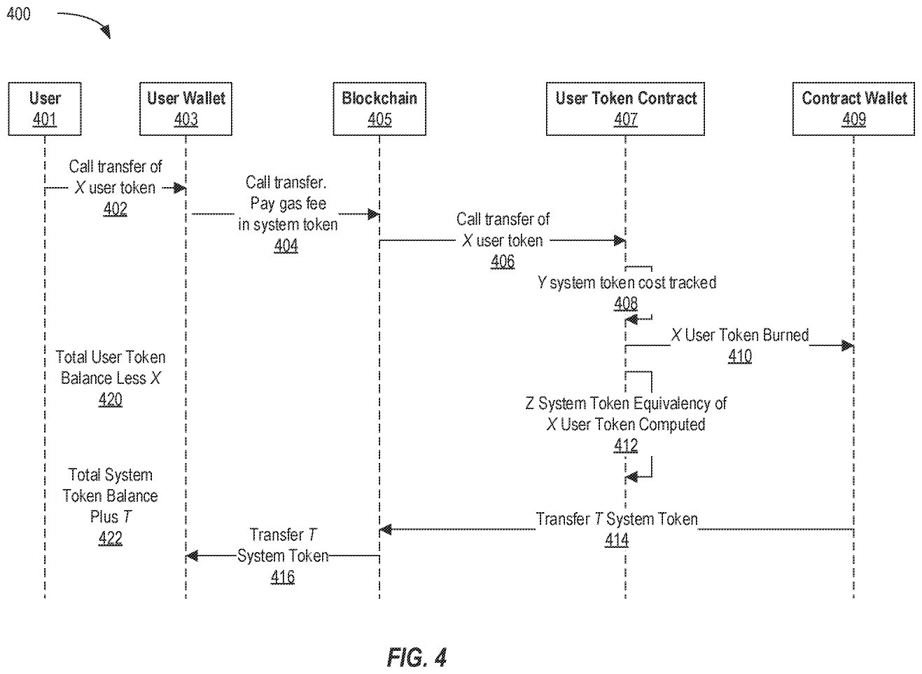

As described in detail with reference to FIG. 4, user 102 may exchange user token 116 for system token 114 through an exchange with smart contract 110. Specifically, user 102 transfers user token 116 to smart contract 110 and receives an equivalent amount of system token 114, according to a dynamically variable exchange rate.

### Example Flow for Transferring User Token on a Blockchain

FIG. 2 depicts an example flowchart 200 for a user transacting on a blockchain using a dynamically adjustable value user token to pay the transaction fees, such as user 102 transacting on blockchain 108, as described above with respect to FIG. 1. Generally, the user will ultimately transact with both user token and system token, however, the user's wallet balance will only reflect the effects of the transaction on the user token because the cost of transacting will be ultimately be paid with user token.

Initially, a first user 201 (e.g., user 102 in FIG. 1) calls a transfer of user token (e.g., user token 116 in FIG. 1) from the first user's wallet 203 (e.g., wallet 106 in FIG. 1) to a second user, (e.g., user 104 in FIG. 1) on a blockchain 205, the transfer including an amount X of user token at step 202. The amount X of user token includes an amount Z of user token to pay transaction fees and an amount W of user token to be transferred to the second user. Because the first user is ultimately paying the transaction fees with user token, the user may readily determine the effect of the transaction on the user's user token balance within the user's wallet before completing the transaction.

At step 204, the first user's wallet 203 calls for the transfer of user token on blockchain 205. The first user's wallet 203 prepays the transaction fees for the transaction by paying an estimate of transaction cost in system token (e.g., system token 114 in FIG. 1), which is used to fund the transaction. In some embodiments, the amount prepaid for transaction fees may be an estimate of the cost of funding the transaction based on the level of activity on blockchain and the complexity of the transaction. In some embodiments, the complexity of the transaction is determined based on the number of steps required to complete the transaction.

At step 206, blockchain 205 triggers the user token smart contract 207 (e.g., smart contract 110 in FIG. 1). In some embodiments, the user token smart contract 207 may be a token creation smart contract, such as an ERC-20 smart contract or an ERC-1155 smart contract. In some embodiments, the user token smart contract receives a deposit of system token that will later be refunded to users transacting with user token. Beneficially, this results in no economic value change for users. For example, where the system token is ETH, such as on an Ethereum network, the system token has a fiat currency value, (e.g., value in US dollars), and refunding the system token to users results in no economic value change. In conventional systems, system token is not refunded, and there is an economic cost for each transaction, realizable in fiat currency value.

At step 208, the user token smart contract 207 tracks the cost Y of the transaction in system token. In some aspects, the cost Y of the transaction in the system token includes the transaction fees associated with the operation of the smart contract and the user token transfer.

At step 210, the user token smart contract 207 determines the amount Z of user token equivalent to the cost Y of the transaction in system token. The value of the user token is dynamic as it adjusts relative to the actual transaction costs associated with the transaction in system token. Thus, the value of the user token is pegged to its utility for paying transaction fees, rather than some fiat currency equivalent. In some embodiments, the value of the user token is mapped to an average cost of transacting on blockchain. For example, one user token may be mapped to the average cost of the previous 100 transactions in system token. In another example, one user token may be mapped to the average cost of all transactions in system token. Thus, user token maintains a consistent utility value, even as the transaction costs it pays for vary. In some embodiments, the user token smart contract burns the amount Z of user token equivalent to the transaction fees. Burning a token, such as user token, removes the token from circulation on blockchain 205. Thus, the user token is considered to be “spent” on the transaction fees and not usable.

At step 212, the user token smart contract 207 transfers the remaining amount W of user token not used to pay the transaction fees to the second user (e.g., user 104 in FIG. 1).

At step 214, the user token smart contract 207 instructs blockchain 205 to transfer of the unused system token to be refunded to the first user 201. Because a user must prepay the transaction fees in system token before the transaction occurs, there may be unused system token. The user token smart contract 207 determines the difference between the amount of system token prepaid by the user's wallet at step 204 and the tracked cost Y of the transaction.

At step 216, this unused system token is transferred to the user's wallet 203 by blockchain 205.

At step 218, the user token smart contract 207 calls for transfer of the cost Y transaction in system token to be reimbursed to the first user 201, from the smart contract wallet 209.

At step 220, the user token smart contract 207 instructs blockchain 205 to reimburse cost Y of the transaction in system token from the smart contract wallet 209 to the user's wallet 203.

At step 222, the reimbursement of Y system token is transferred to the user's wallet 203 by blockchain 205.

Thus, at the conclusion of the transaction, the user's wallet 203 has a total user token balance less X, which includes the amount W transferred to the second user and the Z cost of the transaction fees, as shown at 230. The user's wallet has a total system balance which is unchanged, as shown at 232. Beneficially, the transaction is completed without changing the user's balance of system token despite the requirements of blockchain 205 to pay transaction fees in system token. Thus, transacting using a user token (e.g., user token 116 in FIG. 1) provides a technical solution to the technical problems associated with paying transaction fees in system token, even when transferring non-native token (e.g., user token).

Note that flow 200 is just one example, and other flows including fewer, additional, or alternative steps, consistent with this disclosure, are possible.

### Another Example Flow for Transferring User Token on a Blockchain

FIG. 3 depicts another example flowchart 300 for a user transacting on a blockchain using a dynamically adjustable value token to pay the transaction fees, such as user 102 transacting on blockchain 108, as described above with respect to FIG. 1. Steps 304-308 and 312-314 generally progress as described above with respect to steps 204-208 and 214-216 in FIG. 2. However, in FIG. 3, the system token is reimbursed to the recipient of the user token, rather than returned to the first user, thus allowing the user token smart contract 307 to leverage a transfer of user token between a first user and a second user to share in transaction fees.

At step 302, a first user 301 (e.g., user 102 in FIG. 1) calls a transfer of user token (e.g., user token 116 in FIG. 1) from the first user's wallet 303 (e.g., wallet 106 in FIG. 1) to a second user, (e.g., user 104 in FIG. 1). Unlike in FIG. 2, here in FIG. 3, the transfer include an amount X of user token, which is an amount of user token to transfer to the second user.

Then, steps 304-308 generally proceed as described above with respect to steps 204-208 in FIG. 2.

At step 310, however, the user token smart contract 307 instructs blockchain 305 to transfer the amount X of user token to a second user.

In some embodiments, a second user may exchange the received user token for system token, such as described in detail below with respect to FIG. 4. For example, the second user may burn up 10% of user token received at step 310, in exchange for system token.

Then, steps 312-314 generally proceed as described above with respect to steps 214-216 in FIG. 2.

However, at step 316, the user token smart contract 307 calls for transfer of the cost of the transaction in system token to be reimbursed to the second user. At step 318, the user token smart contract 307 instructs blockchain 305 to reimburse the cost of the transaction in system token from the smart contract wallet 309 to the second user.

In some embodiments, the cost of the transaction reimbursed to the second user is cost Y of the transaction in system token. Beneficially, the second user may share in the transaction cost on behalf of the first user. In some embodiments, the cost of the transaction reimbursed to the second user is a cost of a prior transaction in system token. A second user may be reimbursed for the transaction fees associated with one or more prior transactions in a subsequent transaction. For example, a second user may be reimbursed once daily for all transaction fees associated with all transactions sent by the second user in one day.

Thus, at the conclusion of the transaction, the user's wallet has a total user token balance less X, which is the amount of user token transferred to the second user, as shown at 330. The user's wallet has a total system token balance less Y, which is the amount of system token used to pay the transaction fee, as shown at 332. Beneficially, the user token smart contract leverages the refund and reimbursement steps to allow users to share in transaction costs. In examples where the second user is reimbursed for one or more prior transactions, the user token smart contract reduces the number of reimbursement transactions, thereby reducing transaction fees. Note that flow 300 is just one example, and other flows including fewer, additional, or alternative steps, consistent with this disclosure, are possible.

### Example Flow for Exchanging User Token for System Token on a Blockchain

FIG. 4 depicts example flowchart 400 for a user transacting with a user token smart contract on a blockchain, as described above with respect to FIG. 1. A user (e.g., user 102 in FIG. 1), may exchange user token (e.g., user token 116 in FIG. 1) for system token (e.g., system token 114 in FIG. 1). Steps 404-408 generally progress as described above with respect to steps 204-208 in FIG. 2. However, in FIG. 4, the user token is exchanged for system token, such as to increase a user's balance of system token in the user's wallet for paying transaction fees.

Initially, at step 402, a user 401 calls for a transfer of X user tokens from the user's wallet 403 (e.g., wallet 106 in FIG. 1) to the user token smart contract 407 (e.g., smart contract 110) via a blockchain 405 to exchange for system tokens. The amount X of user token includes an amount of user token to pay transaction fees and an amount Z of user token to be burned for system token. In some embodiments, the user token smart contract receives a deposit of system token to be exchanged to users transacting with user token.

Then, steps 404-408 generally proceed as described above with respect to steps 204-208 in FIG. 2.

However, at 410, the user token smart contract 407 burns amount X of user tokens.

At 412, the user token smart contract 407 calculates the equivalent amount X of user tokens in an amount Z of system token.

At 414, the user token smart contract 407 transfers an amount T of system token on blockchain 405 to the user. The amount T equals Z minus Y, because amount Y of system token must be used to pay for operating the user token smart contract 407.

At 416, blockchain 405 transfers amount T of system tokens to the user's wallet 409.

Thus, at the conclusion of the transaction, the user's total user token balance in the user's wallet 403 is reduced by amount X of user token, as shown at 420 and the user's total system token balance is increased by amount T of system token, as shown at 422. Therefore, the user may beneficially increase system token to pay transaction fees, such as at step 204 in FIG. 2 and step 304 in FIG. 3. Thus, where the user's wallet 409 has sufficient user token to pay transaction fees, an exchange may be used to ensure the user's wallet 409 has the necessary amount of system token to prepay transaction fees, allowing for fluid transactions from a user's perspective.

Note that flow 400 is just one example, and other methods including fewer, additional, or alternative steps, consistent with this disclosure, are possible.

### Example Flow for Transferring User Token on a Blockchain

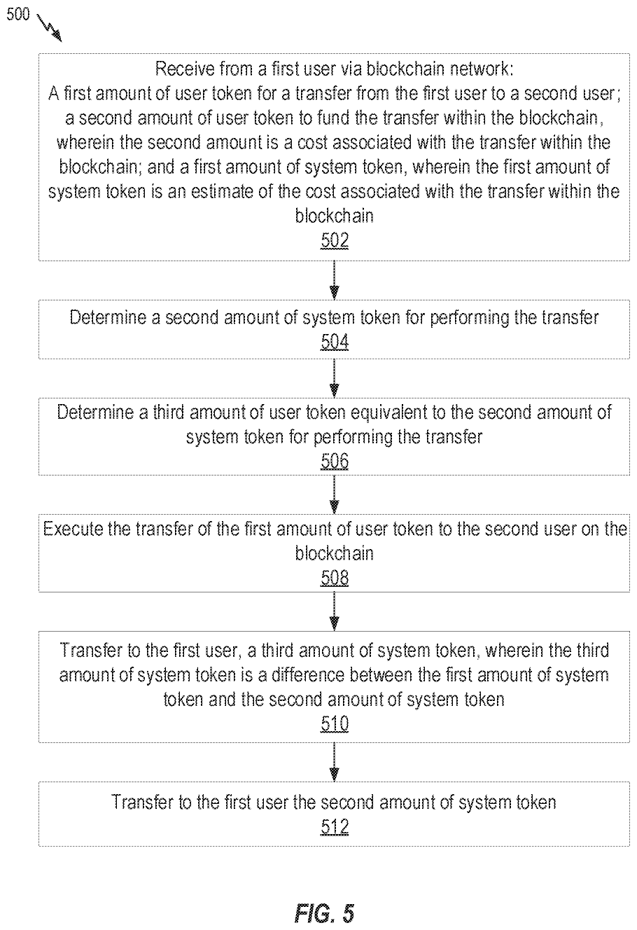

FIG. 5 depicts an example method 500 for transferring user tokens via a blockchain. In some embodiments, method 500 may be performed by a smart contract, such as smart contract 110 in FIG. 1.

Method 500 begins at step 502 with receiving, by a smart contract, such as 110 in FIG. 1, from a first user, via a blockchain: a first amount of user token for a transfer from the first user to a second user; a second amount of user token to fund the transfer within the blockchain, wherein the second amount is a cost associated with the transfer within the blockchain; and a first amount of system token, wherein the first amount of system token is an estimate of the cost associated with the transfer within the blockchain. In some embodiments, the first amount of user token may be the amount W of user token, and the second amount of user token may be the amount Z of user token, as described in FIG. 2.

In some embodiments, the smart contract is an ERC-20 smart contract. In some embodiments, the smart contract is an ERC-115 smart contract.

Method 500 then proceeds to step 504 with determining, by the smart contract, such as 110 in FIG. 1, a second amount of system token for performing the transfer, such as described at step 208 in FIG. 2

In some embodiments, determining, by the smart contract, such as 110 in FIG. 1, the second amount of system token for performing the transfer, comprises: determining a number of steps in the transfer; determining a price associated with each step of the transfer; and generating a cost for performing the transfer based on the determined number of steps and the determined price for each step.

In some embodiments, the price associated with each step of the transfer is based on an activity level of the blockchain. For example, where the activity level of the blockchain is high, the price is high. In another example, where the activity level of the blockchain is low, the price is low.

Method 500 then proceeds to step 506 with determining, by the smart contract, such as 110 in FIG. 1, a third amount of user token equivalent to the second amount of system token for performing the transfer, such as described at step 210 in FIG. 2.

In some embodiments, determining, by the smart contract, such as 110 in FIG. 1, the third amount of user token equivalent to the second amount of system token for performing the transfer, comprises: determining an average cost associated with transacting on the blockchain; mapping a value associated with user token to the determined average cost of transacting on the blockchain; and determining the third amount of user token based on the value associated with the user token and the second amount of system token for performing the transfer.

In some embodiments, determining the average cost associated with transacting on the blockchain, comprises: monitoring a set of previous transfers on the blockchain, determining a cost for each transfer in the set of previous transfers; and determining an average cost associated with the set of previous transfers.

In some embodiments, the second amount of user token and the third amount of user token are the same, regardless of the first amount of system token.

Method 500 then proceeds to step 508 with executing the transfer of the first amount of user token to the second user on the blockchain, such as described at step 212 in FIG. 2.

Method 500 then proceeds to step 510 with transferring to the first user a third amount of system token, wherein the third amount of system token is a difference between the first amount of system token and the second amount of system token, such as described at steps 214-218 in FIG. 2.

Method 500 then proceeds to step 512 with transferring to the first user the second amount of system token, such as described at steps 220-224 in FIG. 2.

In some embodiments, method 500 further comprises receiving a fourth amount of system token into the smart contract.

Beneficially, method 500 provides a technical solution to the technical problems associated with paying transaction fees in system token, even when transferring user token, by reimbursing system token paid for transaction fees and deducting the user token equivalence of the system token from the transfer to the second user.

Note that method 500 is just one example, and other methods including fewer, additional, or alternative steps, consistent with this disclosure, are possible.

### Another Example Flow for Transferring User Token on a Blockchain

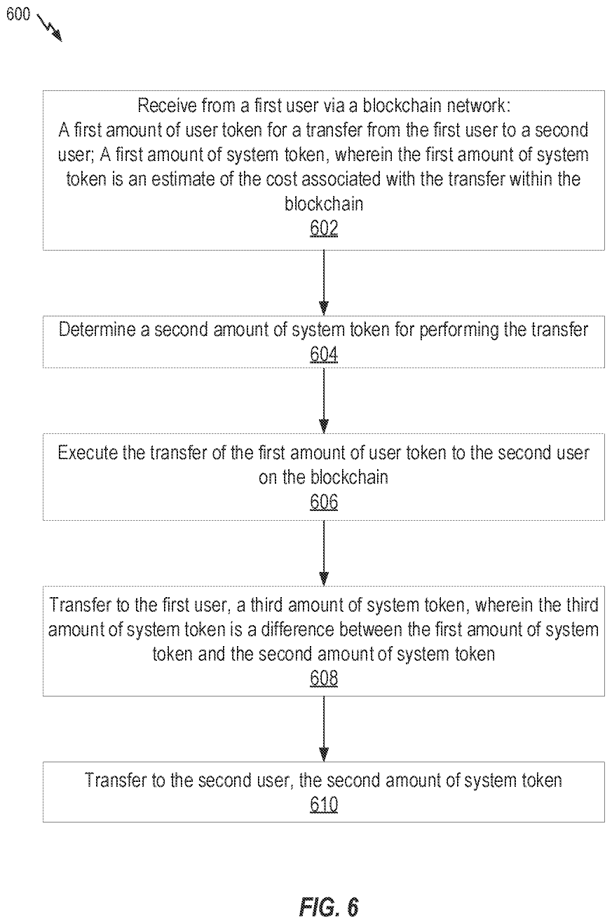

FIG. 6 depicts another example method 600 for transferring user tokens via a blockchain. In some embodiments, method 600 may be performed by a smart contract, such as smart contract 110 in FIG. 1.

In some embodiments, the smart contract is an ERC-20 smart contract. In some embodiments, the smart contract is an ERC-115 smart contract.

Method 600 begins at step 602 with receiving from a first user, via a blockchain: a first amount of user token for a transfer from the first user to a second user; a first amount of system token, wherein the first amount of system token is an estimate of the cost associated with the transfer within the blockchain. For example, a first amount of user token may be an amount X of user token to transfer to the second user and the first amount of system token may be system token to prepay transaction fee, as described in FIG. 3.

Method 600 then proceeds to step 604 with determining a second amount of system token for performing the transfer. For example, the second amount of system token may be the transaction fee, amount Y of system token, tracked throughout the transaction, as described in FIG. 3.

In some embodiments, determining, by the smart contract, the second amount of system token for performing the transfer, comprises; determining a number of steps in the transfer; determining a price associated with each step of the transfer, wherein the price is based on an activity level of the blockchain; and generating a cost for performing the transfer based on the determined number of steps and the determined price for each step. In some embodiments, the price is based on an activity level of the blockchain.

Method 600 then proceeds to step 606 with executing the transfer of the first amount of user token to the second user on the blockchain, such as described at step 306 in FIG. 3.

Method 600 then proceeds to step 608 with transferring to the first user, a third amount of system token, wherein the third amount of system token is a difference between the first amount of system token and the second amount of system token, such as described at steps 312-314 in FIG. 3.

Method 600 then proceeds to step 610 with transferring to the second user, the second amount of system token, such as described at step 318 in FIG. 3.

In some embodiments, method 600 further comprises: executing a second transfer of a fourth amount of user token to the first user, and transferring, by the smart contract, to the first user, a fourth amount of system token, wherein the fourth amount of system token is equivalent to the second amount of system token.

In some embodiments, method 600 further comprises: receiving a deposit of system token into the smart contract.

Beneficially, method 600 provides a technical solution to the technical problems described herein associated with paying transaction fees in system token, even when transferring system token, by allowing users to share in transaction costs and leveraging transactions when reimbursing system token to users.

Note that method 600 is just one example, and other methods including fewer, additional, or alternative steps, consistent with this disclosure, are possible.

### Example Processing System for Operating a User Token

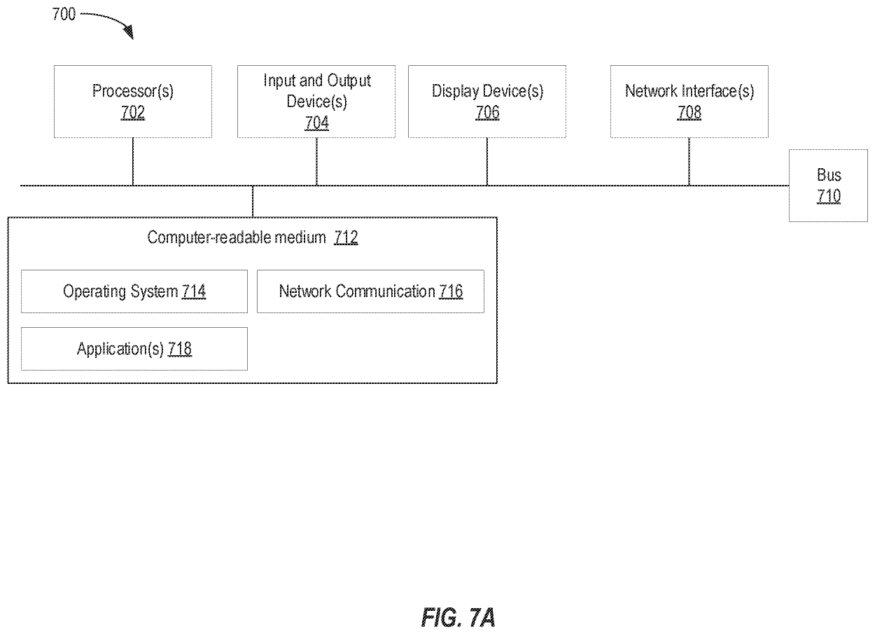

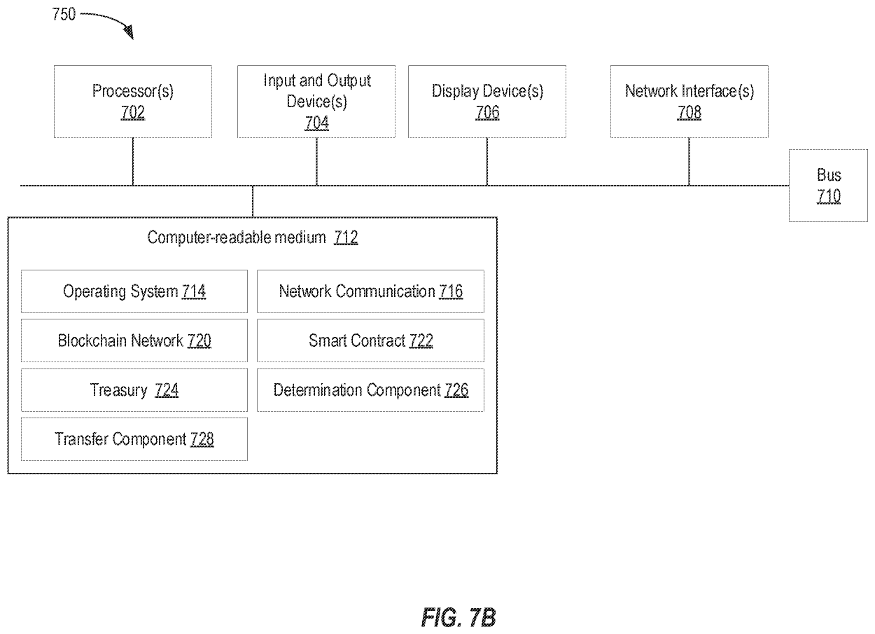

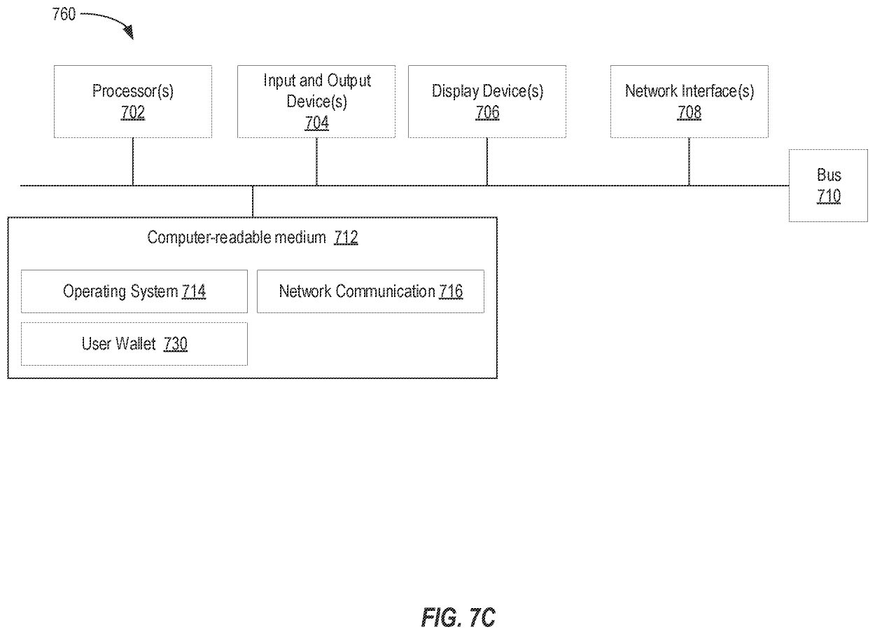

FIGS. 7A-C depict example processing systems configured to perform various aspects described herein, including, for example, flows 200-400, as shown in FIGS. 2-4 and methods 500 and 600, as shown in FIGS. 5 and 6.

In FIG. 7A, processing system 700 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 700 includes one or more processors 702, one or more input/output devices 704, one or more display devices 706, and one or more network interfaces 708 through which processing system 700 is connected to one or more networks (e.g., a local network, an intranet, the Internet, or any other group of processing systems communicatively connected to each other), and computer-readable medium 712.

In the depicted example, the aforementioned components are coupled by a bus 710, which may generally be configured for data and/or power exchange amongst the components. Bus 710 may be representative of multiple buses, while only one is depicted for simplicity.

Processor(s) 702 are generally configured to retrieve and execute instructions stored in one or more memories, including local memories like the computer-readable medium 712, as well as remote memories and data stores. Similarly, processor(s) 702 are configured to retrieve and store application data residing in local memories like the computer-readable medium 712, as well as remote memories and data stores. More generally, bus 710 is configured to transmit programming instructions and application data among the processor(s) 702, display device(s) 706, network interface(s) 708, and computer-readable medium 712. In certain embodiments, processor(s) 702 are included to be representative of a one or more central processing units (CPUs), graphics processing unit (GPUs), tensor processing unit (TPUs), accelerators, and other processing devices.

Input/output device(s) 704 may include any device, mechanism, system, interactive display, and/or various other hardware components for communicating information between processing system 700 and a user of processing system 700. For example, input/output device(s) 704 may include input hardware, such as a keyboard, touch screen, button, microphone, and/or other device for receiving inputs from the user. Input/output device(s) 704 may further include display hardware, such as, for example, a monitor, a video card, and/or other another device for sending and/or presenting visual data to the user. In certain embodiments, input/output device(s) 704 is or includes a graphical user interface.

Display device(s) 706 may generally include any sort of device configured to display data, information, graphics, user interface elements, and the like to a user. For example, display device(s) 706 may include internal and external displays such as an internal display of a tablet computer or an external display for a server computer or a projector. Display device(s) 706 may further include displays for devices, such as augmented, virtual, and/or extended reality devices.

Network interface(s) 708 provide processing system 700 with access to external networks and thereby to external processing systems. Network interface(s) 708 can generally be any device capable of transmitting and/or receiving data via a wired or wireless network connection. Accordingly, network interface(s) 708 can include a communication transceiver for sending and/or receiving any wired and/or wireless communication. For example, Network interface(s) 708 may include an antenna, a modem, a LAN port, a Wi-Fi card, a WiMAX card, cellular communications hardware, near-field communication (NFC) hardware, satellite communication hardware, and/or any wired or wireless hardware for communicating with other networks and/or devices/systems. In certain embodiments, network interface(s) 708 includes hardware configured to operate in accordance with the Bluetooth® wireless communication protocol.

Computer-readable medium 712 may be a volatile memory, such as a random access memory (RAM), or a nonvolatile memory, such as nonvolatile random access memory, phase change random access memory, or the like. In this example, computer-readable medium 712 includes various instructions for implementing an operating system 714, instructions for implementing network communication 716 to establish and maintain network connections, and one or more applications 718.

FIG. 7B depicts another example processing system 750 for performing one or more aspects of the flows and methods described herein. Components 702-712 may operate as generally described above with reference to FIG. 7A.

In this example processing system 750, computer-readable medium 712 includes various instructions for implementing an operating system 714, instructions for implementing network communication 716 to establish and maintain network connections, blockchain 720, smart contract 722, treasury 724, determination component 726, and transfer component 728.

In certain embodiments, blockchain 720 is configured to execute transfers of user token and system token on the blockchain.

In certain embodiments, smart contract 722, such as user token smart contract 207 in FIG. 2, user token smart contract 307 in FIG. 3, or user token smart contract 407 in FIG. 4, is configured to receive user token, including user token for transfer from the first user to a second user; system token as an estimate of the cost associated with the transfer within the blockchain; and user token to fund the transfer within the blockchain. In certain embodiments, treasury 724, such as user token smart contract wallet 209 in FIG. 2, user token smart contract wallet 309 in FIG. 3, or user token smart contract wallet 409 in FIG. 4, is configured to transfer system token to a user via a blockchain.

In certain embodiments, determination component 726 is configured to determine a second amount of system token for performing the transfer, including determining a number of steps in the transfer; determining a price associated with each step of the transfer, wherein the price is based on an activity level of the blockchain; and generating a cost for performing the transfer based on the determined number of steps and the determined price for each step. In certain embodiments, determination component 726 is configured to determine the user token equivalent to system token, including determining an average cost associated with transacting on the blockchain; mapping a value associated with user token to the determined average cost of transacting on the blockchain; and determining the third amount of user token based on the value associated with the user token and the second amount of system token for performing the transfer.

In certain embodiments, transfer component 728 is configured to transfer a third amount of system token, wherein the third amount of system token is a difference between the first amount of system token and the second amount of system token. In certain embodiments, transfer component 728 is configured to transfer to the first user, the second amount of system token. In certain embodiments, transfer component 728 is configured to transfer to the second user, the second amount of system token. In certain embodiments, transfer component 728 is configured to transfer to the first user, a fourth amount of system token, wherein the fourth amount of system token is equivalent to the second amount of system token.

FIG. 7C depicts another example processing system 760 for performing one or more aspects of the flows and methods described herein. Components 702-712 may operate as generally described above with reference to FIG. 7A.

In this example processing system 760, computer-readable medium 712 includes various instructions for implementing an operating system 714, instructions for implementing network communication 716 to establish and maintain network connections, and user wallet 730.

In certain embodiments, user wallet 730 is configured to hold a user's tokens, including user token, system token, and non-fungible token.

Note that FIGS. 7A-7C are examples of processing systems consistent with aspects described herein, and other processing systems having additional, alternative, or fewer components are possible consistent with this disclosure.

### Example Clauses

Implementation examples are described in the following numbered clauses:

Clause 1: A method, comprising: receiving, by a smart contract, from a first user via a blockchain: a first amount of user token for a transfer from the first user to a second user; a second amount of user token to fund the transfer within the blockchain, wherein the second amount is a cost associated with the transfer within the blockchain; and a first amount of system token, wherein the first amount of system token is an estimate of the cost associated with the transfer within the blockchain; determining, by the smart contract, a second amount of system token for performing the transfer; determining, by the smart contract, a third amount of user token equivalent to the second amount of system token for performing the transfer; executing the transfer of the first amount of user token to the second user on the blockchain; transferring, by the smart contract, to the first user, a third amount of system token, wherein the third amount of system token is a difference between the first amount of system token and the second amount of system token; and transferring, by the smart contract, to the first user, the second amount of system token.

Clause 2: The method of Clause 1, further comprising: receiving a deposit of system token into the smart contract.

Clause 3: The method of any one of Clauses 1-2, wherein determining, by the smart contract, the second amount of system token for performing the transfer, comprises; determining a number of steps in the transfer; determining a price associated with each step of the transfer; and generating a cost for performing the transfer based on the determined number of steps and the determined price for each step.

Clause 4: The method of Clause 3, wherein the price is based on an activity level of the blockchain.

Clause 5: The method of any one of Clauses 1-4, wherein determining, by the smart contract, the third amount of user token equivalent to the second amount of system token for performing the transfer, comprises: determining an average cost associated with transacting on the blockchain; mapping a value associated with user token to the determined average cost of transacting on the blockchain; and determining the third amount of user token based on the value associated with the user token and the second amount of system token for performing the transfer.

Clause 6: The method of Clause 5, wherein determining the average cost associated with transacting on the blockchain, comprises: monitoring a set of previous transfers on the blockchain; determining a cost for each transfer in the set of previous transfers; and determining an average cost associated with the set of previous transfers.

Clause 7: The method of any one of Clauses 1-6, wherein the second amount of user token and the third amount of user token are the same, regardless of the first amount of system token.

Clause 8: The method of any one of Clauses 1-7, wherein the smart contract is an ERC-20 smart contract.

Clause 9: A method, comprising: receiving, by a smart contract, from a first user via a blockchain: a first amount of user token for a transfer from the first user to a second user; a first amount of system token, wherein the first amount of system token is an estimate of the cost associated with the transfer within the blockchain; determining, by the smart contract, a second amount of system token for performing the transfer; executing the transfer of the first amount of user token to the second user on the blockchain; transferring, by the smart contract, to the first user, a third amount of system token, wherein the third amount of system token is a difference between the first amount of system token and the second amount of system token; and transferring, by the smart contract, to the second user, the second amount of system token.

Clause 10: The method of Clause 9, further comprising: executing a second transfer of a fourth amount of user token to the first user, and transferring, by the smart contract, to the first user, a fourth amount of system token, wherein the fourth amount of system token is equivalent to the second amount of system token.

Clause 11: The method of any one of Clauses 9-10, further comprising: receiving a deposit of system token into the smart contract.

Clause 12: The method of any one of Clauses 9-11, wherein determining, by the smart contract, the second amount of system token for performing the transfer, comprises; determining a number of steps in the transfer; determining a price associated with each step of the transfer, wherein the price is based on an activity level of the blockchain; and generating a cost for performing the transfer based on the determined number of steps and the determined price for each step.

Clause 13: The method of Clause 12, wherein the price is based on an activity level of the blockchain.

Clause 14: The method of any one of Clauses 9-13, wherein the smart contract is an ERC-20 smart contract.

Clause 15: A processing system, comprising: a memory comprising computer-executable instructions; and a processor configured to execute the computer-executable instructions and cause the processing system to perform a method in accordance with any one of Clauses 1-14.

Clause 16: A processing system, comprising means for performing a method in accordance with any one of Clauses 1-14.

Clause 17: A non-transitory computer-readable medium storing program code for causing a processing system to perform the steps of any one of Clauses 1-14.

Clause 18: A computer program product embodied on a computer-readable storage medium comprising code for performing a method in accordance with any one of Clauses 1-14.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method, comprising:
receiving, by a smart contract, from a first user via a blockchain:
a first amount of user token for a transfer from the first user to a second user;
a second amount of user token to fund the transfer within the blockchain, wherein the second amount of user token is a transfer fee for processing the transfer within the blockchain; and
a first amount of system token, wherein the first amount of system token is an estimate of the transfer fee for processing the transfer within the blockchain;
determining, by the smart contract, a second amount of system token for processing the transfer within the blockchain;
determining, by the smart contract, a third amount of user token equivalent to the second amount of system token for processing the transfer within the blockchain, comprising:
determining an average transfer fee associated with transacting on the blockchain;
mapping a value associated with user token to the determined average transfer fee associated with transacting on the blockchain; and
determining the third amount of user token based on the value associated with the user token and the second amount of system token for processing the transfer within the blockchain;
executing the transfer of the first amount of user token to the second user on the blockchain;
transferring, by the smart contract, to the first user, a third amount of system token, wherein the third amount of system token is a difference between the first amount of system token and the second amount of system token; and
transferring, by the smart contract, to the first user, the second amount of system token.

2. The method of claim 1, further comprising receiving a deposit of system token into the smart contract.

3. The method of claim 1, wherein determining, by the smart contract, the second amount of system token for processing the transfer within the blockchain, comprises;
determining a number of steps in the transfer;
determining a price associated with each step of the transfer; and
generating a transfer fee for processing the transfer within the blockchain based on the determined number of steps and the determined price for each step.

4. The method of claim 3, wherein the price is based on an activity level of the blockchain.

5. (canceled)

6. The method of claim 1, wherein determining the average transfer fee associated with transacting on the blockchain, comprises:
monitoring a set of previous transfers on the blockchain,
determining a transfer fee for each transfer in the set of previous transfers; and
determining an average transfer fee associated with the set of previous transfers.

7. The method of claim 1, wherein the second amount of user token and the third amount of user token are the same, regardless of the first amount of system token.

8. The method of claim 1, wherein the smart contract is an ERC-20 smart contract.

9. A method, comprising:
receiving, by a smart contract, from a first user via a blockchain:
a first amount of user token for a transfer from the first user to a second user;
a first amount of system token, wherein the first amount of system token is an estimate of a transfer fee for processing the transfer within the blockchain based on an average transfer fee associated with transacting on the blockchain;
determining, by the smart contract, a second amount of system token for performing the transfer, comprising:
determining a number of steps in the transfer;
determining a price associated with each step of the transfer; and
generating a transfer fee for performing the transfer based on the determined number of steps and the determined price for each step
executing the transfer of the first amount of user token to the second user on the blockchain;
transferring, by the smart contract, to the first user, a third amount of system token, wherein the third amount of system token is a difference between the first amount of system token and the second amount of system token; and
transferring, by the smart contract, to the second user, the second amount of system token.

10. The method of claim 9, further comprising:
executing a second transfer of a fourth amount of user token to the first user, and
transferring, by the smart contract, to the first user, a fourth amount of system token, wherein the fourth amount of system token is equivalent to the second amount of system token.

11. The method of claim 9, further comprising: receiving a deposit of system token into the smart contract.

12. (canceled)

13. The method of claim 9, wherein the price is based on an activity level of the blockchain.

14. The method of claim 9, wherein the smart contract is an ERC-20 smart contract.

15. A processing system, comprising: a memory comprising computer-executable instructions; and a processor configured to execute the computer-executable instructions and cause the processing system to:
receive, by a smart contract, from a first user via a blockchain:
a first amount of user token for a transfer from the first user to a second user;
a second amount of user token to fund the transfer within the blockchain, wherein the second amount of user token is a transfer fee for processing the transfer within the blockchain; and
a first amount of system token, wherein the first amount of system token is an estimate of the transfer fee for processing the transfer within the blockchain;
determine, by the smart contract, a second amount of system token for performing the transfer;
determine, by the smart contract, a third amount of user token equivalent to the second amount of system token for performing the transfer, comprising:
determine an average transfer fee associated with transacting on the blockchain;
map a value associated with user token to the determined average transfer fee associated with transacting on the blockchain; and
determine the third amount of user token based on the value associated with the user token and the second amount of system token for processing the transfer within the blockchain;
execute the transfer of the first amount of user token to the second user on the blockchain;
transfer, by the smart contract, to the first user, a third amount of system token, wherein the third amount of system token is a difference between the first amount of system token and the second amount of system token; and
transfer, by the smart contract, to the first user, the second amount of system token.

16. The processing system of claim 15, wherein the processor is further configured to cause the processing system to deposit a fourth amount of system token into the smart contract.

17. The processing system of claim 15, wherein in order to determine, by the smart contract, the second amount of system token for performing the transfer, the processor is further configured to cause the processing system to:
determine a number of steps in the transfer;
determine a price associated with each step of the transfer; and
generate a transfer fee for performing the transfer based on the determined number of steps and the determined price for each step.

18. The processing system of claim 17, wherein the price is based on an activity level of the blockchain.

19. (canceled)

20. The processing system of claim 15, wherein in order to determine the average transfer fee associated with transacting on the blockchain, the processor is further configured to cause the processing system to:
monitor a set of previous transfers on the blockchain,
determine a transfer fee for each transfer in the set of previous transfers; and
generate an average transfer fee associated with the set of previous transfers.

21. The method of claim 1, further comprising burning, by the smart contract, the third amount of user token equivalent to the second amount of system token for processing the transfer within the blockchain.

22. The method of claim 1, wherein the smart contract is an ERC-115 smart contract.

23. The processing system of claim 15, wherein the processor is further configured to cause the processing system to burn, by the smart contract, the third amount of user token equivalent to the second amount of system token for processing the transfer within the blockchain.
